(19) United States
(12) Patent Application Publication
(10) Pub. No.: US 2012/0221630 A1
(43) Pub. Date: Aug. 30, 2012

(54) SERVER

(75) Inventors: Hiroshi Kawazoe, Kanagawa-ken (JP); Takuya Kawamura, Kanagawa-ken (JP)

(73) Assignee: KABUSHIKI KAISHA TOSHIBA, Tokyo (JP)

(21) Appl. No.: 13/420,161

(22) Filed: Mar. 14, 2012

Related U.S. Application Data
(63) Continuation of application No. PCT/JP2009/007369, filed on Dec. 29, 2009.

(51) Int. Cl. G06F 15/16

(52) U.S. Cl. 709/203

(57) ABSTRACT

A server comprising: a detector that detects a run command of an application; a CPU load calculating unit that calculates a CPU load; a screen image transmission load calculating unit that calculates a screen image transmission load; a server runtime load calculating unit that calculates a server runtime load; a client runtime load calculating unit that calculates a client runtime load; a determining unit that determines which runs the application, the server or the client; a running unit that runs the application; and a transmitter that transmits the running information on the application to the client.

### CROSS-REFERENCE TO RELATED APPLICATION

This application is a continuation of International Application No. PCT/JP2009/007369, filed Dec. 29, 2009, the entire contents of which are incorporated herein by reference.

### FIELD

Embodiments described herein relate generally to servers, and in particular, to a server that transfers screen images to clients.

### BACKGROUND

Traditionally, “a screen image transfer system” is known that packetizes desktop screen images of a server and delivers the packets of them in real time from the server to clients connected via networks to the server. This system allows the users of remote client computers to view the desktop screen images of a server and can achieve efficient working environments between the server and the clients via networks.

One method that establishes the screen image transfer system described above is to packetize only the updated parts in the displaying area in the desktop screen image of a server together with their coordinates to deliver them to clients each time an update occurs in the displaying area.

This screen image transfer system may experience the deterioration in the quality of screen image transfer, such as the dropping frames or delay in screen image transmission due to lapsing into the overload in the processing on a server or clients.

For instance, the technique according to a prior art prevents the overload in the processing on a server by either the server or a client running applications based on the CPU utilization of the server.

The technique according to a prior art, allows information about video replay (such as video data) to be transmitted to a client and to be played and displayed on the client, when a server captures that the operation for video replay is being performed.

In other prior art, however, the deterioration in the quality of screen image transfer may be experienced even when a client running applications is selected based on the high CPU utilization of a server. For example, when a client runs applications and a server transmits a file required for running the applications to a client, the delay in the screen display on the client can be occurred because it takes time to transmit said file due to insufficient network bandwidth and, therefore, takes time before starting to run applications.

In the prior art, the deterioration in the quality of screen image transfer may also be experienced when a client plays video. For example, insufficient network bandwidth and poor ability of processing may cause the client to become overloaded, which may result in the dropping frames or delay in video image transmission, and the insufficient transmission of the information to the client.

Thus, the related art has a problem that causes the deterioration in the quality of screen image transfer, such as dropping frames or delay. In a monitoring system via networks, etc. among others, the delay of early countermeasures due to delay of the notice, from a server to clients, of the detection of a problem engenders serious effects.

It is an object of the present invention to provide a server that improves the quality of screen image transfer from the server to clients.

The server according to one aspect of the present invention is characterized by including a detector that detects a run command of an application, a CPU load calculating unit that calculates a CPU load of when the own server or a client runs the application, a screen image transmission load calculating unit that calculates a screen image transmission load of when the server runs the application, a server runtime load calculating unit that calculates from the CPU load and the screen image transmission load a server runtime load when the own server runs the application, a client runtime load calculating unit that calculates from the CPU load a client runtime load when the client runs the application, a determining unit that determines which runs the application, the server or the client, from the server runtime load and the client runtime load, an application running unit that runs the application when the determining unit determines that the server runs the application, a transmitter that transmits the running information on the application to the client when the determining unit determines that the client runs the application.

The server according to the present invention can improve the quality of screen image transfer from the server to clients.

### BRIEF DESCRIPTION OF THE DRAWINGS

FIG. 1 is a diagram of a screen image transfer system according to a first example of the present invention.

FIG. 2 is a block diagram of a configuration of a server and a client according to the first example of the present invention.

FIG. 3 is a diagram of an example of the screen updating information that the server produces according to the first example of the present invention.

FIG. 4 is a flowchart of the operationₜof the server according to the first example of the present invention.

FIG. 5 is a diagram of a correspondence table of the type of an application to the evaluated value of a CPU load.

FIG. 6 is a diagram of a correspondence table of the type of an application to the evaluated value of a screen image transmission load.

FIG. 7 is a diagram of a correspondence table of CPU utilization to the evaluated value of CPU utilization.

FIG. 8 is a block diagram of modified parts of the server of FIG. 2.

### DETAILED DESCRIPTION

Examples according to the present invention will be described below.

### First Example

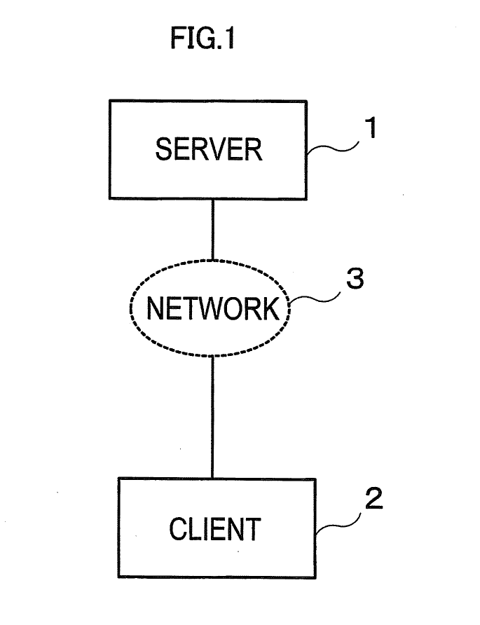

FIG. 1 is a diagram of the relationship of a screen image transfer system according to a first example. This screen image transfer system is a system that displays the desktop screen images of a server 1 on the screen of a client 2 by transmitting the desktop screen images of the server 1 to the client 2 over a network 3. The network 3 is a network 3 compliant with a wire communications protocol, such as IEEE802.3. The form of the network 3 is not limited to this and may be made up of a network compliant with other protocols, such as a wireless communications protocol defined by IEEE802.11.

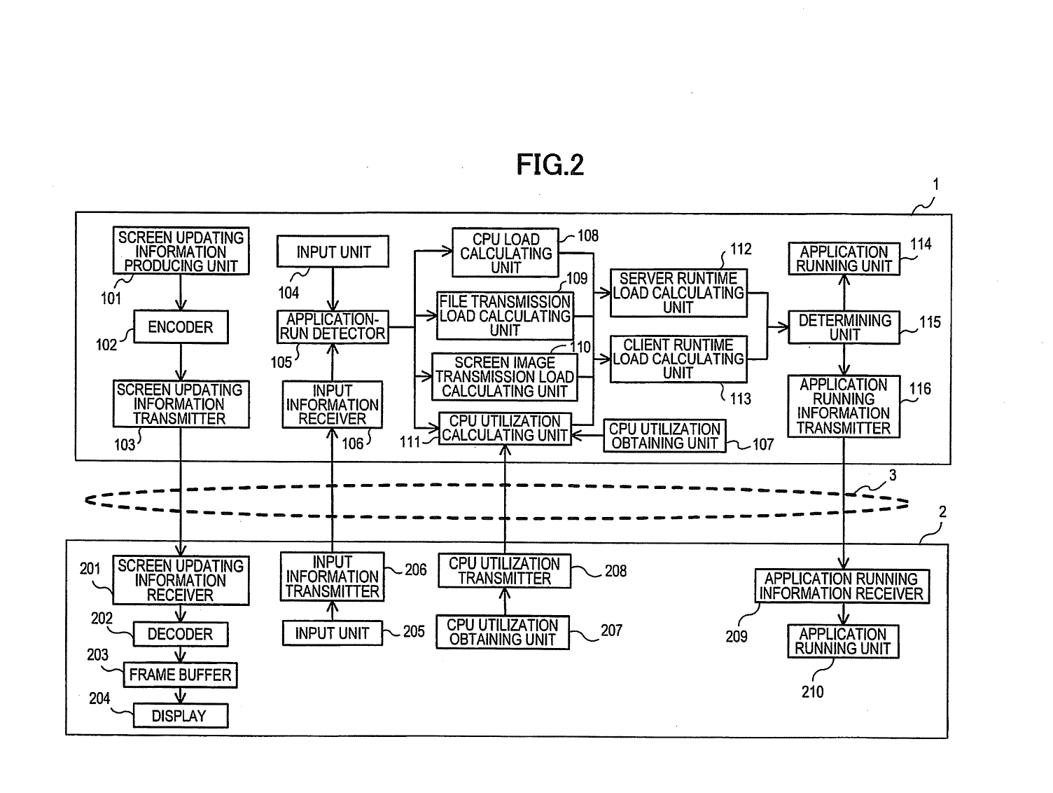

FIG. 2 is a block diagram of the server 1 and client 2 described above.

The server 1 includes a screen updating information producing unit 101, an encoder 102, a screen updating information transmitter 103, an input unit 104, an application-run detector 105, an input information receiver 106, a CPU load calculating unit 108, a file transmission load calculating unit 109, a screen image transmission load calculating unit 110, a CPU utilization calculating unit 111, a CPU utilization obtaining unit 107, a server runtime load calculating unit 112, a client runtime load calculating unit 113, an application running unit 114, a determining unit 115, an application running information transmitter 116.

The server 1 of the screen image transfer system according to this example is a device that, when the server 1 receives a run command of an application, determines which runs said application, the server 1 or the client 2, and allows the device determined, to run said application. To make said determination accurate, the server 1 estimates and calculates the load of each of the server 1 and client 2 of when each of the server 1 and client 2 runs the application.

First, the server 1 calculates the CPU load of each of the client 2 and server 1 of when the application is run, with the CPU load calculating unit 108. The server 1 then calculates the screen image transmission load of the server 1 of when the server runs the application, with the screen image transmission load calculating unit 110 and calculates the file transmission load of the client 2 of when the client 2 runs the application, with the file transmission load calculating unit 109. The CPU utilization calculating unit 111 calculates the CPU utilization of each of the server 1 and client 2 at the time a run command of the application is received.

The server 1 calculates a server runtime load of when the server 1 runs the application, from said calculated CPU load, CPU utilization, and screen image transmission load of the server 1, with the server runtime load calculating unit 112. The server 1 also calculates a client runtime load of when the client 2 runs the application, from said calculated CPU load, CPU utilization, and file transmission load of the client 1, with the client runtime load calculating unit 113. The determining unit 115 of the server 1 determines which runs the application, the server 1 or the client 2, by comparing the magnitude relation between said calculated server runtime load and client runtime load.

When the determining unit 115 of the server 1 determines that the server 1 runs the application, the application running unit 114 that runs the application is allowed to run. On the other hand, when the determining unit 115 of the server 1 determines that the client 2 runs the application, the application running information transmitter 116 transmits the run command of the application to the client 2. When the client 2 receives the run command of said application, the client 2 allows the application running unit 210 to run the application.

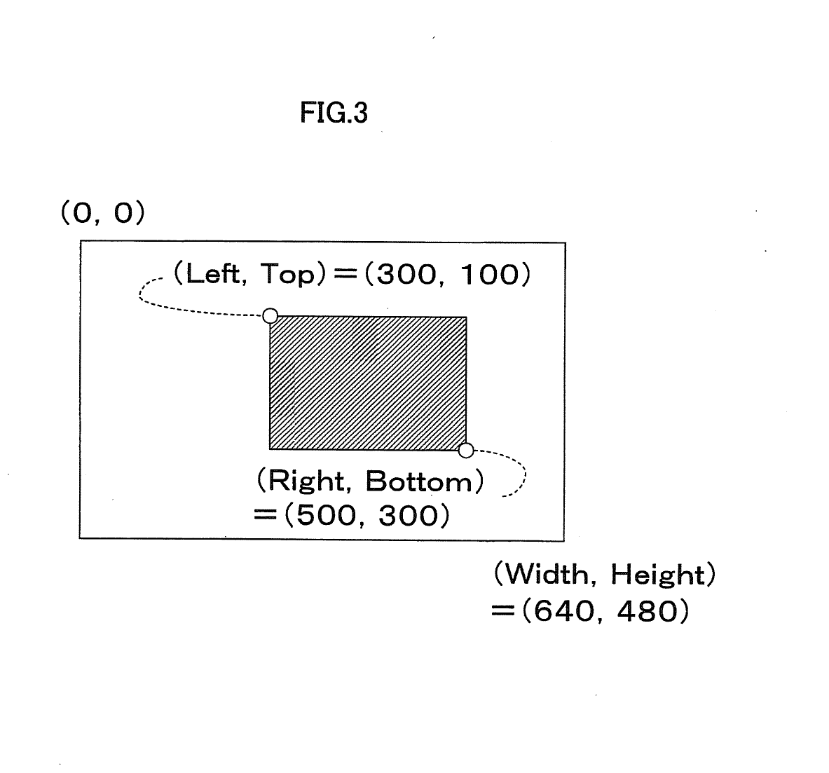

The screen updating information producing unit 101 produces OS (operating system) run on the server 1 and screen updating information depending on the operational state of the application. FIG. 3 is a diagram of an example of the screen updating information. The screen updating information is the screen information to obtain the latest imaging condition of a part of the desktop screen image as shown in FIG. 3.

The screen updating information includes two types of information, area information that defines an area in the desktop and image information in said area. The latest imaging condition of the desktop of the server 1 can be obtained by overwriting to update the data of the area that the area information defines, with the image information of the updating image information, on the frame buffer that stores immediately before imaging condition of the desktop.

The encoder 102 applies arbitrary compression processing to the image information when the encoder 102 receives the screen updating information.

The screen updating information transmitter 103 transmits the screen updating information to which the encoding process is applied, to the client 2 over the network 3. When the client 2 receives the screen updating information, the client 2 decodes it with a decoder 202 and overwrites the screen updating information in a frame buffer 203. Then, a display 204 displays the updated screen image.

Next, methods of detecting a run command of an application and of calculating the load of each of the client 1 and server 2 are described in detail.

The input unit 104 receives an input operation to the server 1 from a user, converts the input operation into input information, and outputs it. The input unit 104 is, for example, a mouse and a keyboard.

The input information receiver 106 receives the input information from the user of the client 2 from the client 2 over the network 3.

When the application-run detector 105 receives the input information from the input unit 104 or the input information receiver 106, the application-run detector 105 detects whether said input information means a run command of the application on the server 1. When the application-run detector 105 detects that said input information is a run command, the application-run detector 105 outputs the type of the application to which said run command is issued, to the CPU load calculating unit 108, the file transmission load calculating unit 109, the screen image transmission load calculating unit 110, and the CPU utilization calculating unit 111, respectively.

Each calculating unit calculates the expected values of the load of when each of the client 1 and server 2 runs the application.

When the CPU load calculating unit 108 receives the type of the application from the application-run detector 105, the CPU load calculating unit 108 estimates the size of the CPU load of when the server 1 or client 2 runs said application and converts the size of the CPU load into the evaluated value on the quality of screen image transfer (the evaluated value of CPU load). For example, the evaluated value on the quality of screen image transfer (the evaluated value of CPU load) is determined as a numerical value given depending on the size of the CPU load.

When the file transmission load calculating unit 109 receives the type of the application from the application-run detector 105, the file transmission load calculating unit 109 estimates the required file transmission quantity from the server 1 to client 2 when the client 2 runs said application and converts the required file transmission quantity into the evaluated value on the quality of screen image transfer (the evaluated value of file transmission load). For example, the evaluated value on the quality of screen image transfer (the evaluated value of file transmission load) is determined as a numerical value depending on, e.g., the data size of the file estimated to be transmitted. Since said file transmission takes place only when the client 2 runs the application, the evaluated value of file transmission load is calculated as an evaluated value of when the client 2 runs the application.

When the screen image transmission load calculating unit 110 receives the type of the application from the application-run detector 105, the screen image transmission load calculating unit 110 estimates the frequency of screen image transfer per unit time from the server 1 to client 2 when the server 1 runs said application, and the screen image transmission load calculating unit 110 converts the frequency of screen image transfer per unit time into the evaluated value on the quality of screen image transfer (the evaluated value of screen image transmission load). The evaluated value of screen image transmission load is determined as a numerical value depending on the value of the updated number of pixels per unit time related to the screen updating information, the update of pixels occurring, for example, when the application is run. Since said screen image transfer takes place only when the server 1 runs the application, the evaluated value of screen image transmission load is calculated as the load of when the server 1 runs the application.

When the CPU utilization calculating unit 111 receives the type of the application from the application-run detector 105, the CPU utilization calculating unit 111 obtains from the CPU utilization obtaining unit 107 the CPU utilization of the server 1 at the time of receiving the type of the application and converts the CPU utilization of the server 1 into the evaluated value on the quality of screen image transfer (the evaluated value of CPU utilization). Also, the CPU utilization calculating unit 111 similarly obtains from the client 2 over the network 3 the CPU utilization of the client 2 at the time the CPU utilization calculating unit 111 receives the type of the application, and the CPU utilization calculating unit 111 similarly converts into the evaluated value of CPU utilization.

The CPU utilization obtaining unit 107 is a unit that obtains the CPU utilization of the server 1 at the time using an arbitrary method.

The server runtime load calculating unit 112 calculates, from the evaluated value on the quality of screen image transfer from the CPU load calculating unit 108, the file transmission load calculating unit 109, the screen image transmission load calculating unit 110, and the CPU utilization calculating unit 111, the evaluated value on the quality of screen image transfer of when the server 1 runs the application (the evaluated value of server runtime load).

The calculation of the evaluated value of server runtime load is calculated as the sum of the evaluated values on the quality of screen image transfer in, for example, the CPU load calculating unit 108, the screen image transmission load calculating unit 110, and the CPU utilization calculating unit 111. That is, the evaluated value of server runtime load is the sum of the evaluated values of the CPU load of the server 1, the screen image transmission load, and the CPU utilization of the server 1. As described above, since the evaluated value of file transmission load is not calculated when the server 1 runs the application, the evaluated value of file transmission load is not involved in the calculation of the evaluated value of server runtime load.

The client runtime load calculating unit 113 calculates, from the evaluated value on the quality of screen image transfer from the CPU load calculating unit 108, the file transmission load calculating unit 109, the screen image transmission load calculating unit 110, and the CPU utilization calculating unit 111, the evaluated value on the quality of screen image transfer of when the client 2 runs said application (the evaluated value of client runtime load). The calculation of the evaluated value of client runtime load is calculated, for example, as the sum of the evaluated values of the CPU load of the client 2, the file transmission load, and the CPU utilization of the client 2. As described above, since screen image transmission load does not take place when the client 2 runs the application, screen image transmission load is not involved in the calculation of client runtime load.

The determining unit 115 determines which runs the application, the server 1 or the client 2, based on the evaluated value of server runtime load and the evaluated value of client runtime load calculated by the server runtime load calculating unit 112 and the client runtime load calculating unit 113. The determining unit 115 determines which runs the application, the server 1 or the client 2, for example, by comparing the magnitude relation between the evaluated value of server runtime load and the evaluated value of client runtime load. When the determining unit 115 determines that the server 1 runs the application, the run command of said application is issued to the application running unit 114. When the determining unit 115 determines that the client 2 runs the application, the running information on said application is output to the application running information transmitter 116.

When the determining unit 115 determines that the server 1 runs the application, the application running unit 114 runs said application.

When the determining unit 115 determines that the client 2 runs the application, the application running information transmitter 116 transmits the running information on the application to the client 2 over the network 3.

Next, in the server 1 according to this example, the method of determining which runs an application, the server 1 or the client 2, depending on the type of the application is specifically described.

As described above, when the server 1 runs the application, the processing that the server 1 runs the application and the processing that transfers from the server 1 to client 2 the screen images of the screen updating information drawn by running the application to allow the client 2 to draw the display images according to said screen updating information are required.

On the other hand, when the client 2 runs the application, the processing that transfers from the server 1 to client 2 a document file necessary to run the application and the processing that the client 2 runs the application are required.

The determining unit 115 estimates the load of when each of the server 1 and client 2 runs the application and determines which runs the application, the server 1 or the client 2, according to the size of said loads.

It is described below which should run the application, the server 1 or the client 2, for example, when the application is a video file of small data size. When the server 1 plays video, a lot of screen image transfer takes place during video replay. The constraints, such as the upper limit of the network band, can therefore cause the client 2 to experience dropping frames, etc. In this instance, not the server 1 but the client 2 preferably plays video after transmission of the video file to the client 2.

Thus, when the application is a video file of small data size, the client 2 preferably runs the application because heavy screen image transfer load is required when the server 1 runs the application.

Next, it is described below which should run the application, the server 1 or the client 2, when a text editor application is used to edit a document file of large file size. The document file needs to be transmitted to the client 2 when the client 2 runs the application. In this instance, the constraints, such as the upper limit of the network band, may cause the client 2 starting to view the document file to take too long or cause the dropping frames or delay in the transmission of other screen updating information that occur while transmitting the document file. In such a case, rather than transmitting the document file, it is preferable to run a text editor on the server 1, edit a document file on the server 1, and then transfer the screen images of the updating image information to the client 2. Thus, when an application is used to edit a document file of large file size with a text editor, the server 1 preferably runs the application because heavy file transmission load is required when the client 2 runs the application.

Next, a configuration of the client 2 shown in FIG. 2 is described.

The client 2 includes a screen updating information receiver 201, the decoder 202, the frame buffer 203, the display 204, an input unit 205, an input information transmitter 206, a CPU utilization obtaining unit 207, a CPU utilization transmitter 208, an application running information receiver 209, and the application running unit 210.

The screen updating information receiver 201 receives screen updating information from the server 1 over the network 3.

The decoder 202 applies a proper decoding process to the image information when the decoder 202 receives the screen updating information.

The frame buffer 203 has a storage area to store the screen image of the entire display screen image that the display 2 of the client 2 displays. When the frame buffer 203 receives the screen updating information from the decoder 202, the frame buffer 203 overwrites to update the screen data of the portion that the area information included in the screen updating information defines, with the screen information included in the screen updating information.

The display 204 displays the screen data stored in the frame buffer 203. When the screen data stored in the frame buffer 203 is updated with the screen updating information, the displayed screen data is also updated.

The input unit 205 receives an input operation from a user, converts the input operation into input information, and outputs it to the input information transmitter 206. The input unit 205 includes, for example, a mouse and a keyboard.

The input information transmitter 206 transmits the input information to the server 1 over the network 3.

The CPU utilization obtaining unit 207 obtains the CPU utilization of the client 2 at the time using an arbitrary method.

The CPU utilization transmitter 208 transmits the CPU utilization obtained by the CPU utilization obtaining unit 207 to the server 1 over the network 3.

The application running information receiver 209 receives the application running information including the type of the application from the server 1 over the network 3.

When the application running unit 210 receives the application running information from the application running information receiver 209, the application running unit 210 runs the application corresponding to the type of the application specified by said information.

Next, the processing performed by the screen image transfer system according to this example is described. The server 1 and client 2 are connected to each other over the network 3, both of which are assumed to be transferring screen images.

First, the processing where the server produces screen updating information is described.

When being transferring screen images, the screen updating information producing unit 101 of the server 1 checks whether the visual information presented to a user is updated through the changes of the operational state of OS and various applications run on the server 1, and screen updating information is produced when an update is found. The screen updating information producing unit 101 produces screen updating information by extracting the difference between pieces of the visual information before and after the update using an arbitrary method. As an alternative, screen updating information may be obtained by directly hooking the screen updating information that OS issues. The screen updating information producing unit 101 outputs the produced screen updating information to the encoder 102.

The encoder 102 applies an encoding process to the screen information when the encoder 102 receives the screen updating information. The encoder 102 performs compression processing as an encoding process using an arbitrary algorithm, such as JPEG (Joint Photographic Experts Group) or gzip (GNU ZIP), to the data of bitmap. Next, the encoder 102 outputs the encoded screen updating information to the screen updating information transmitter 103. The screen updating information transmitter 103 converts the screen updating information into an appropriate form to transmit into the network 3, for example, by attaching a TCP (Transmission Control Protocol) header and IP (Internet Protocol) header to the information and then transmits the information into the network 3.

When the screen updating information receiver 201 of the client 2 receives the screen updating information from the network 3, the screen updating information receiver 201 eliminates the above-described TCP header and IP header. The screen updating information receiver 201 outputs the screen updating information to the decoder 202.

When the decoder 202 receives the screen updating information, the decoder 202 applies a decoding process to the screen updating information and draws into the frame buffer 203 based on said screen information.

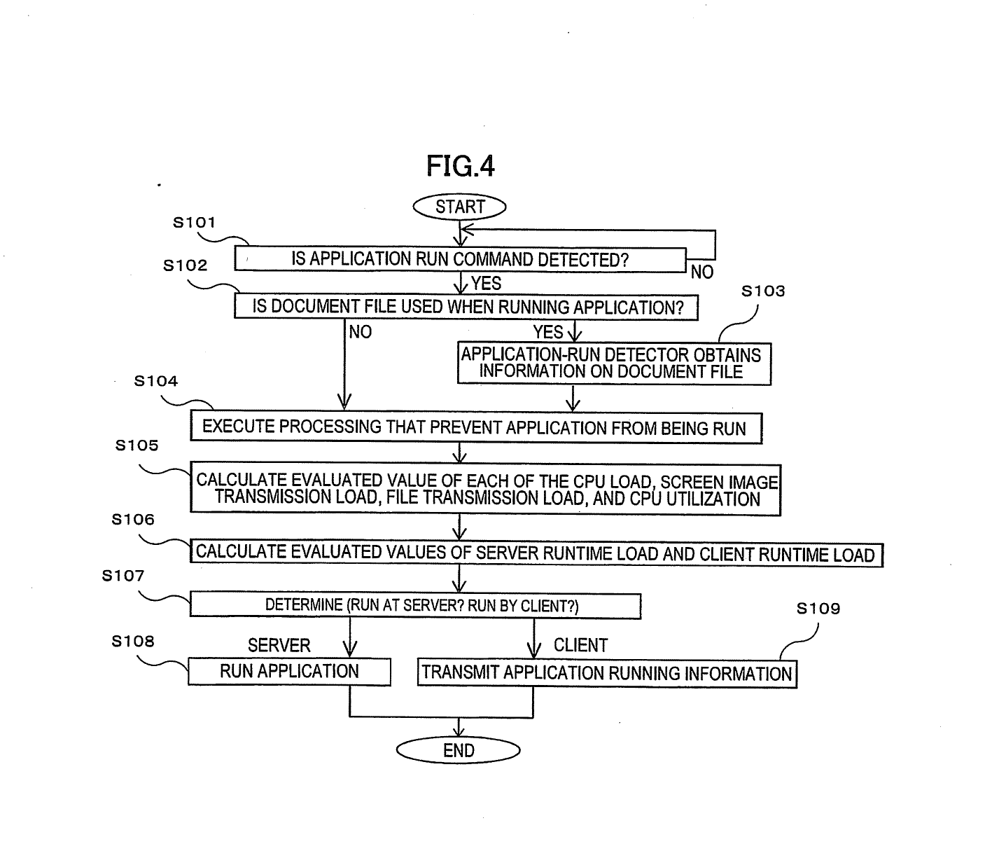

Next, the processing is described that determines which runs an application, the server 1 or the client 2, when the run command of said application is detected on the server 1. FIG. 4 is a flowchart for explaining the processing performed at the time of the detection of a run command of an application.

The input unit 104 of the server 1 produces input information depending on the operation of a user, such as the move of a mouse, the click of a mouse button, and pressing a key of a keyboard. The input information includes, for example, the type of input that represents the type of the input unit 104 (a mouse or keyboard). When the type of input is a mouse, the input information further includes the coordinates of a mouse cursor in the desktop, the move of a wheel, and the value representing various flags indicating the operational state of a button. Also, when the type of input is a keyboard, the input information further includes a key code and the value representing various flags indicating the operational state of a key. The input unit 104 outputs said input information to the application-run detector 105 each time the input information is produced.

On the other hand, the input unit 205 of the client 2 also similarly produces input information depending on the operation of a user. The input information transmitter 206 converts the input information into an appropriate form to transmit into the network 3 by attaching a TCP header to the information and then transmits the information into the network 3. When the input information receiver 106 of the server 1 receives the input information from the network 3, the input information receiver 106 eliminates the above-described TCP header, obtains the input information, and outputs to the application-run detector 105.

The application-run detector 105 can deal with the input information received from the input unit 104 of the server 1 and the input information received from the input unit 205 of the client 2 without distinguishing them. The application-run detector 105 can obtain the position information about the configuration of each GUI (Graphical User Interface) in the desktop using an arbitrary method. The application-run detector 105 determines whether said input information is a run command of an arbitrary application in the server 1 each time the input information is received.

Some examples of the method of determining that a run command of an application is issued are cited. As the first example, the application-run detector 105 obtains the layout of program icons and shortcut icons in the desktop and the type of the application associated with each icon. When the received input information is the doubleclick operation of a mouse or the pressing operation of the Enter key of a keyboard over said icon, it is determined that a run command of an application is issued.

As the second example, also when the launcher area of an application is detected in a user's opening the Start menu of the desktop, and over said area the click operation of a mouse or the pressing operation of the Enter key of a keyboard is performed, it is determined that a run command of an application is issued.

As the third example, when a click operation or the pressing operation of the Enter key is performed over the icon of a document file, it is determined that the run command of the application associated with said document file is issued. Also, as the fourth example, when the drag-and-drop operation of a mouse to a program icon of a document file is performed, it is detected that a run command of an application is issued.

In the above-mentioned description, although the application-run detector 105 detects a run command of an application using the input information from the input unit, the application-run detector 105 can also detect a run command of an application using the information other than the input information from the input unit. For example, when OS provides the mechanism to notify of the run event of an application, the application may detect the run command of the application from said run event.

When the application-run detector 105 detects a run command of an application (S101), after obtaining the type of the application to which the run command is issued, the application-run detector 105 detects whether a document file is used when running said application (S102). When the application-run detector 105 detects that a document file is used, the application-run detector 105 further obtains information on the document file (such as the path of the file) (S103).

Next, although said application is supposed to be run, the application-run detector 105 executes a processing that prevents said application from being run (S104). Next, the application-run detector 105 outputs the type of the application to the CPU load calculating unit 108, the file transmission load calculating unit 109, the screen image transmission load calculating unit 110, and the CPU utilization calculating unit 111, respectively, and the application-run detector 105 instructs each calculating unit to start the calculation of the evaluated value on the quality of screen image transfer.

When the application-run detector 105 has obtained the document file and the information on the document file, the application-run detector 105 outputs said information all together. Next, each of the calculating units 108 to 111 calculates the evaluated value on the quality of screen image transfer (S105).

Next, the method of calculating the evaluated value on the quality of screen image transfer in each of the calculating units 108 to 111 is described.

Each of the calculating units 108 to 111 calculates the evaluated value on the quality of screen image transfer according to the following procedure, and outputs the result to each of the server runtime load calculating unit 112 and client runtime load calculating unit 113.

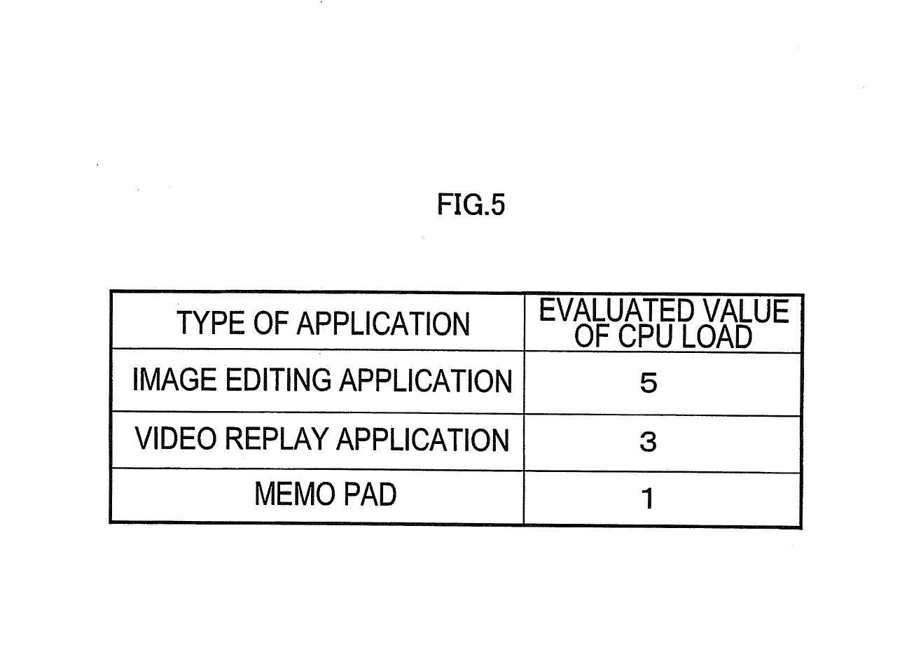

The CPU load calculating unit 108 estimates the increment of the CPU load of when the server 1 or client 2 runs an application, and calculates the evaluated value on the quality of screen image transfer (the evaluated value of CPU load). The evaluated value of CPU load is the value depending on the size of the CPU load. The evaluated value of CPU load can be obtained using, for example, a correspondence table of the type of an application to the evaluated value of a CPU load. FIG. 5 is an example of said correspondence table.

FIG. 5 lists the evaluated values of a CPU load of when each application of the various applications is run. For example, the evaluated value of CPU load is five when the type of the application being run is an image editing application. Also, the evaluated value of CPU load is one when the type of the application being run is a memo pad application.

Although the CPU load calculating unit 108 may set and hold a predetermined value as the evaluated value of CPU load to the type of an application in this way, the CPU load calculating unit 108 need not constantly set a predetermined value as the evaluated value of CPU load to the type of an application. For example, the CPU utilization of said application may be measured at the right time, a large evaluated value of CPU load is set when the CPU utilization is high, a small evaluated value of CPU load is set when the CPU utilization is low, and a correspondence table may be accordingly updated. Thus, the appropriate update of a correspondence table enables determination in consideration of the latest CPU usage of an application at any given time.

When a document file and information on the document file are included in the input from the application-run detector 105, the file transmission load calculating unit 109 estimates the transmission quantity to transmit said document file from the server 1 to client 2 when the client 2 runs an application, and calculates the evaluated value on the quality of screen image transfer (the evaluated value of file transmission load).

When the document file is previously transmitted from the server 1 to client 2 to run the application on the client 2, the larger the file size of said document file is, the longer it takes to transmit said document file. This results in increased waiting time for starting the application on the client 1 and decreased convenience of a user. The evaluated value of file transmission load is now set depending on data size of a document file. For example, the evaluated value of file transmission load is set according to the criterion of “add the evaluated value 1 per 3 megabytes.”

The evaluation criterion of file transmission load need not necessarily use the above-described one. For example, as an alternative, the performance of a network card of the server 1 or the like is checked, for example, at the start of screen image transfer from the server 1 to client 2, and accordingly, the criterion may be dynamically modified and used. Thus, the result of the performance check of a network card can be reflected in the setting of the evaluation criterion of file transmission load in such a manner that the effect of data size of a document file on file transmission load is insignificant when the performance of a network card is high, and the effect of data size of a document file on file transmission load is significant when the performance of a network card is low, and consequently, the performance check of a network card has the advantage of enabling the determination of how to modify the evaluation criterion of file transmission load based on the performance of equipment, such as a network card.

Also, as an alternative, the load condition of the network 3 at the time the file transmission load is calculated is checked, and in response, the evaluated value may be modified. That is, it is determined that, when the congested network 3 causes the available bandwidth to get narrow temporarily, the effect of file size is significant. Thus, reflecting the load condition of a network in the calculation of the value of file transmission load has the advantage of enabling the determination of how to modify the evaluated value of file transmission load in consideration of the state of the network 3 at any given time.

The screen image transmission load calculating unit 110 estimates the frequency of screen image transfer processing performed when the server 1 runs an application and calculates the evaluated value on the quality of screen image transfer (the evaluated value of screen image transmission load). When the server 1 runs an application, the above-described processing performed on screen updating information is applied to each screen image drawing performed in said application. Therefore, when the frequency of screen image drawing performed in said application is increased, the processing load of the server 1 and client 2 and the consumption of a network band are increased, which might result in the deterioration in the quality of screen image transfer.

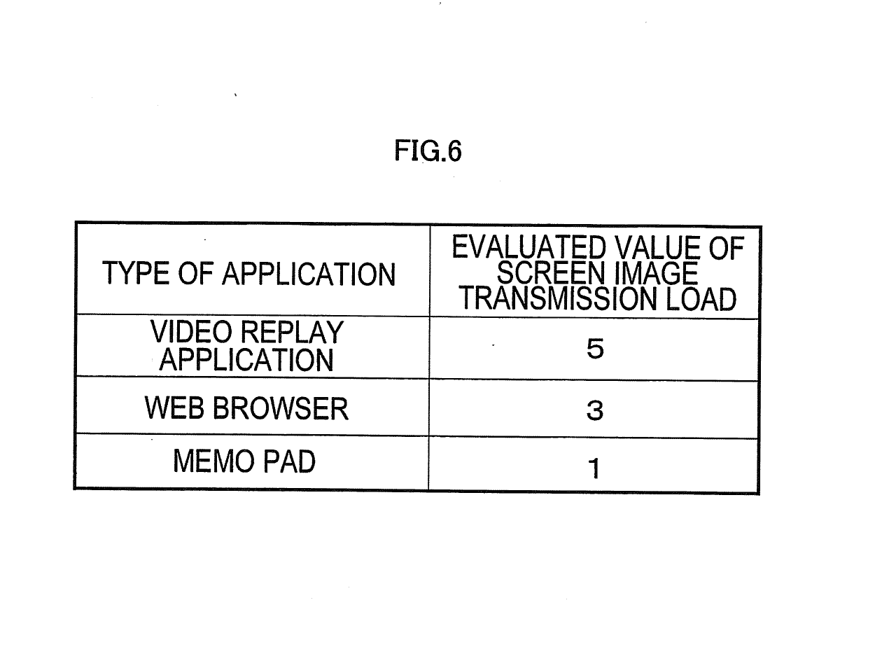

The screen image transmission load calculating unit 110 calculates the evaluated value of screen image transmission load using a correspondence table of the type of an application to the evaluated value of a screen image transmission load. FIG. 6 is an example of a correspondence table of the type of an application to the evaluated value of a screen image transmission load. FIG. 6 lists the evaluated values of the screen image transmission loads to various applications. The evaluated value of a screen image transmission load is a value depending on the updated number of pixels per unit time, the update of pixels occurring in said application. For example, when the type of an application is a video replay application, the corresponding evaluated value is five. When the type of an application is a memo pad application, the corresponding evaluated value is one.

Although the screen image transmission load calculating unit 110 may set and hold a predetermined value as the evaluated value of screen image transmission load to the type of an application in this way, the screen image transmission load calculating unit 110 need not constantly set a predetermined value as the evaluated value of screen image transmission load to the type of an application. The occurrence frequency of the screen updating information of each application may be obtained, for example, by checking to which application said screen updating information belongs each time the screen updating information producing unit 101 produces screen updating information, and according to the size of the obtained occurrence frequency, the evaluated value of the screen image transmission load of said application may be updated.

Thus, obtaining the occurrence frequency of the screen updating information of each application and reflecting the obtained occurrence frequency in the evaluated value of screen image transmission load have the advantage of enabling the determination of how to set the evaluated, value of screen image transmission load in consideration of the latest frequency of the update of the screen updating information of an application constantly.

The CPU utilization calculating unit 111 obtains the current CPU utilization of each of the server 1 and client 2, and calculates the evaluated value on the quality of screen image transfer (the evaluated value of CPU utilization) from the obtained current CPU utilization. To perform this, the CPU utilization calculating unit 111 first requests from the CPU utilization obtaining unit 107 to read the current CPU utilization of the server 1. In response, the CPU utilization obtaining unit 107 measures the current CPU utilization of the server 1 and replies the value to the CPU utilization calculating unit 111. Next, the CPU utilization calculating unit 111 requests the client 2 over the network 3 to read the current CPU utilization of the client 2.

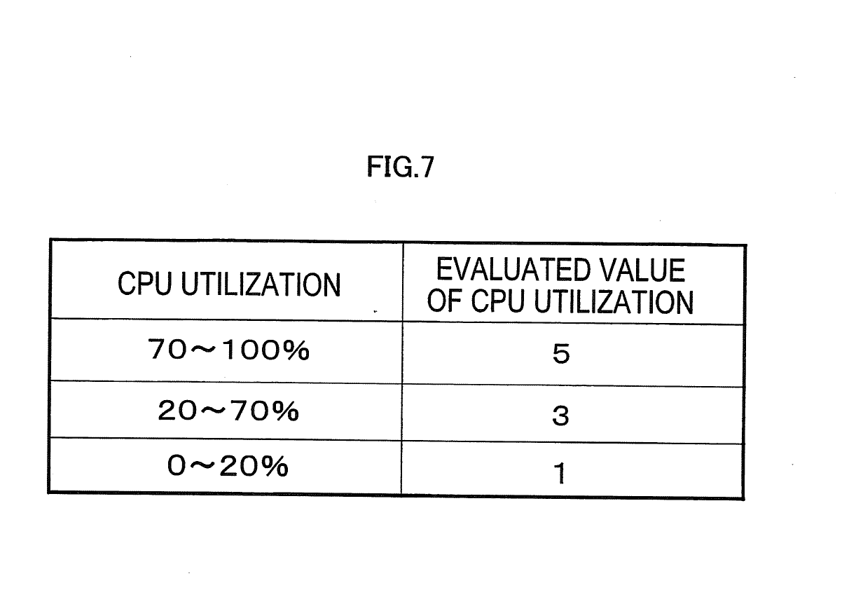

In response, the CPU utilization obtaining unit 207 of the client 2 measures the current CPU utilization of the client 2 and replies the value through the CPU utilization transmitter 208. When the CPU utilization calculating unit 111 receives these values, the CPU utilization calculating unit 111 converts these values into the evaluated values of CPU utilization. Said conversion is calculated using a correspondence table of CPU utilization to the evaluated value of CPU utilization. FIG. 7 is an example of the correspondence table. FIG. 7 lists the evaluated value of CPU utilization corresponding to each CPU utilization. The CPU utilization calculating unit 111 can calculate the evaluated value of CPU utilization using this correspondence table.

Although the CPU utilization calculating unit 111 may set and hold the predetermined evaluated value of each CPU utilization in this way, the CPU utilization calculating unit 111 need not constantly set a predetermined evaluated value to CPU utilization. After measuring the CPU performance of the server 1 and client 2, for example, at the start of screen image transfer, a correspondence table can be updated in such a way that a lower evaluated value is set than usual, for example, when a high-end CPU is used. This enables the appropriate determination of how to modify the correspondence table of the evaluated value of CPU utilization depending on the CPU performance of the server 1 and client 2. The CPU utilization calculating unit 111 need not obtain CPU utilization each time the CPU utilization calculating unit 111 receives a request of calculation of an evaluated value, and the CPU utilization calculating unit ill may be so controlled that once an evaluated value is obtained, it continues to be used for a while. This enables the load required for obtaining CPU utilization to be reduced.

The method of calculating the evaluated value on the quality of screen image transfer in the respective calculating units 108 to 111 has been described above.

Next, the processing of the server runtime load calculating unit 112 and client runtime load calculating unit 113 is described.

When the server runtime load calculating unit 112 receives all the evaluated values onscreen image transfer from the respective calculating units 108 to 111, the server runtime load calculating unit 112 calculates, from these evaluated values, the evaluated value on the quality of screen image transfer of when the server 1 runs an application (the evaluated value of server runtime load) (S106). The server runtime load calculating unit 112 calculates the sum of the evaluated value of the CPU load that the application consumes on the server 1, the evaluated value of the screen image transmission load occurring in said application, and the evaluated value of the current CPU utilization of the server 1. Said sum is assumed to be the evaluated value on the quality of screen image transfer of when the server 1 runs the application (the evaluated value of server runtime load).

Although the sum of the above-described values is assumed to be as the evaluated value of server runtime load, an arbitrary calculating formula is applicable to obtain the evaluated value. When the server 1 runs the application, a document file need not be transferred. Therefore, when the evaluated value of server runtime load is calculated, the evaluated value of file transmission load is not reflected. (Hence, there is no need to wait for input of the evaluated value of file transmission load into the server runtime load calculating unit 112.) On the other hand, When the client runtime load calculating unit 113 receives all the evaluated values from the respective calculating units 108 to 111, the client runtime load calculating unit 113 calculates, from these evaluated values, the evaluated value on the quality of screen image transfer of when the client 2 runs the application (the evaluated value of client runtime load) (S106). The client runtime load calculating unit 113 calculates the sum of the evaluated value of the CPU load that the application consumes on the client 2, the evaluated value of file transmission load required for transmitting a document file, and the evaluated value of the current CPU utilization of the client 2. Said sum is assumed to be the evaluated value on the quality of screen image transfer of when the client 2 runs the application (the evaluated value of client runtime load).

Although the sum of the above-described values is assumed to be as the evaluated value of client runtime load, an arbitrary calculating formula is applicable to obtain the evaluated value. Also when the client 2 runs the application, screen image transfer does not take place. Therefore, when the evaluated value of server runtime load is calculated, the evaluated value of screen image transmission load is not reflected. (Hence, there is no need to wait for input of the evaluated value of screen image transmission load into the client runtime load calculating unit 113.)

The server runtime load calculating unit and the client runtime load calculating unit 113 each outputs the evaluated value of server runtime load and the evaluated value of client runtime load to the determining unit 115. When the determining unit 115 receives both the evaluated values, the determining unit 115 determines which runs the application, the server 1 or the client 2 (S107). The determining unit 115 determines by comparing the magnitude relation between the evaluated value of server runtime load and the evaluated value of client runtime load. Thereby, when the determining unit 115 determines that the server 1 runs the application, the determining unit 115 notifies the information on the running of the application (the path of the executable file of the application and a document file) to the application running unit 114, which in turn runs said application (S108).

On the other hand, when the determining unit 115 determines that the client 2 runs the application, the determining unit 115 notifies the information on the running of the application to the application running information transmitter 116. The application running information transmitter 116 adds information, such as a TCP header, to the information on the running of the application and then transmits the information into the network 3 (S109). When the application running information receiver 209 of the client 2 receives the information on the running of the application, the application running information receiver 209 eliminates the TCP header, etc. and passes said information to the application running unit 210, which in turn runs said application.

Next, a specific example of the processing is shown that determines which runs an application, the server 1 or the client 2, when the run command of the application is detected. In a following example, the processing of when a user double-clicks a video icon on the desktop and the application-run detector 105 thereby detects a replay command of a video file is described.

Now, assume that the data size of the video file is 10 megabytes and the CPU utilization of both the server 1 and the client 2 is 10%. Assume that the CPU load calculating unit 108, the file transmission load calculating unit 109, the screen image transmission load calculating unit 110, and the CPU utilization calculating unit 111 calculate evaluated values according to the above-mentioned example.

The CPU load calculating unit 108 calculates the evaluated value of the CPU load for a video replay application to be 3 according to the correspondence table of FIG. 5. The file transmission load calculating unit 109 calculates the evaluated value corresponding to 10 megabytes to be 4 according to the above-mentioned criterion of “add the evaluated value 1 per 3 megabytes.” The screen image transmission load calculating unit 110 calculates the evaluated value for the video replay application to be 5 according to FIG. 6. The CPU utilization calculating unit 111 calculates the evaluated value for each of the server 1 and client 2 to be 1.

The evaluated values calculated by these calculating units 108 to 111 are input into the server runtime load calculating unit 112 and client runtime load calculating unit 113. The server runtime load calculating unit 112 calculates the evaluated value of the server runtime load to be the sum of the evaluated values calculated by the CPU load calculating unit 108, the screen image transmission load calculating unit 110, and the CPU utilization calculating unit 111, that is, 3+3+1=7.

On the other hand, The client runtime load calculating unit 113 calculates the client runtime load to be the sum of the evaluated values calculated by the CPU load calculating unit 108, the file transmission load calculating unit 109, and the CPU utilization calculating unit 111, that is, 3+4+1=8.

These evaluated values of the server runtime load and the client runtime load are input into the determining unit 115. The determining unit 115 compares the magnitude relation between both the evaluated values and determines that the server 1 that has a smaller evaluated value runs the application. As a result, the application running information is transmitted to the application running unit 114 and the server 1 runs the application.

The example of determining which runs an application, the server 1 or the client 2, has been described above. The procedure described above allows the overloaded status of the server 1 or client 2 in the screen image transfer system to be avoided and the quality of screen image transfer to be ensured.

When determining, the CPU load or network load of screen image transfer processing associated with application drawing, and the file transfer load provided by transfer processing of the document file necessary for running an application are also considered in addition to the CPU load provided by running an application. Thus, it can be more precisely determined which runs an application, the server 1 or the client 2. Taking the CPU utilization at the time of the detection of a run command into consideration also allows for the determination depending on the running state of each of the client and server 1 at any given time. The improved quality of screen image transfer can consequently be achieved.

### First Variation

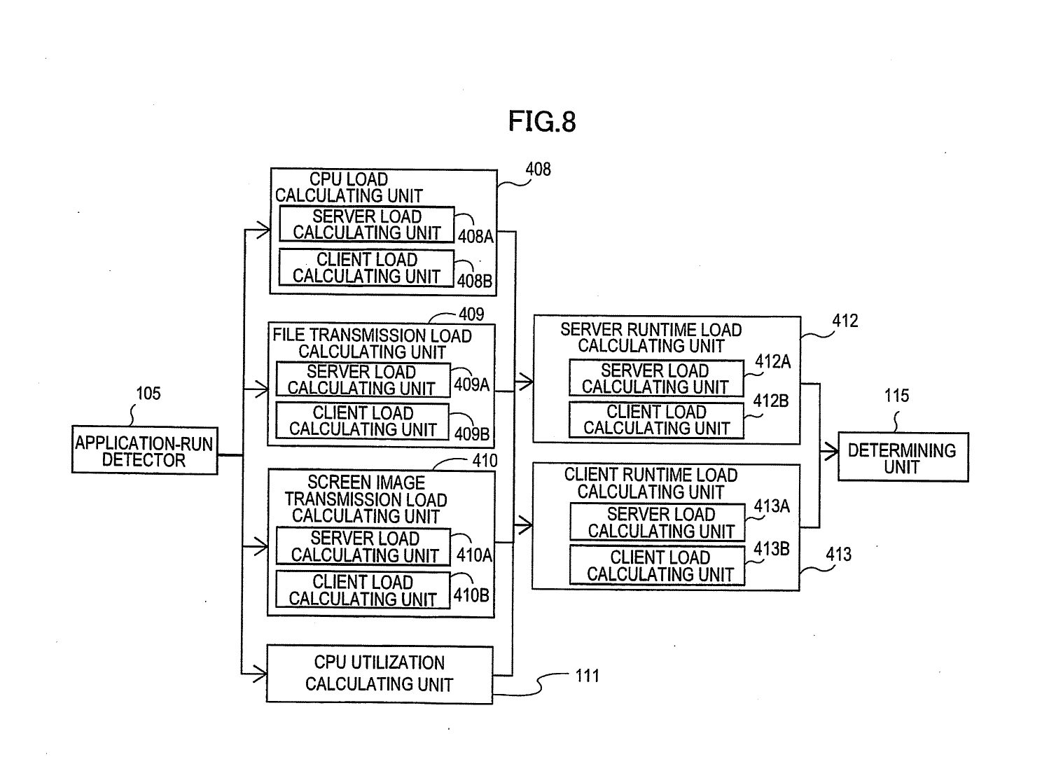

Next, the variation of the server 1 in the first example is described. FIG. 8 is a configuration of parts having a different function from the server 1 of FIG. 2.

The server 1 of the first variation separately calculates the evaluated value of the load of the server 1 and the evaluated value of the load of the client 2 as the evaluated value on the quality of screen image transfer of when the server 1 runs an application (the evaluated value of server runtime load). Also, as the evaluated value of client runtime load of when the client 2 runs the application, the evaluated value of the load of the server 1 and the evaluated value of the load of the client 2 are separately calculated.

The server 1 determines which runs an application, the server 1 or the client 2, based on the evaluated value of the load of each of the server 1 and client 2 of when each device, the server 1 or the client 2, runs the application. Also, to calculate the evaluated value of server runtime load and the evaluated value of client runtime load separately for the server 1 and for the client 2 in this way, each of the evaluated value of CPU load, the evaluated value of file transmission load, and the evaluated value of screen image transmission load are also calculated separately for the server 1 and for the client 2.

When the server 1 and the client 2 have differences in performance, such as CPU performance, network performance, and still image encoding and decoding performance, providing the foregoing function allows different evaluation criterions to be set for the server 1 and the client 2, respectively, when calculating an evaluated value. Therefore, since the server 1 according to this variation allows a decision to be made which can run an application, the server 1 or the client 2, based on the performance of the server 1 and client 2, the server 1 can improve the quality of screen image transfer from the server 1 to client 2.

Next, the specific configuration and operation of the server 1 of this variation are described. In the following description, it is described when the server 1 has standard CPU and network performance and the client 2 has higher performance than the server 1. Also, in the following description, the example of when the application-run detector 105 detects a start operation command of a video replay is described.

A CPU load calculating unit 408 includes a server load calculating unit 408A and a client load calculating unit 408B. The CPU load calculating unit 408 calculates the evaluated value of CPU load using the table set in FIG. 5 and further calculates the value that reflects the CPU performance of each of the server 1 and client 2 as the evaluated value of CPU load.

Specifically, the CPU load calculating unit 408 obtains the value (such as a clock frequency) that shows the CPU performance of each of the server 1 and client 2, for example, at the start of screen image transfer and calculates the different evaluated value of CPU load for each of the server 1 and client 2 depending on the obtained value that shows the CPU performance. For example, when the CPU performance exceeds a specified value, the CPU load calculating unit 408 calculates as an evaluated value the value that is the evaluated value set in FIG. 5 minus 1.

Now, assume that the CPU performance of the server 1 is less than the specified value and the CPU performance of the client 2 is equal to or more than the specified value. Since the CPU performance of the server 1 is less than the specified value, the server load calculating unit 408A sets the value shown in FIG. 5, or 3, as the evaluated value of the CPU load for the server 1 at the time of the detection of a video replay command. On the other hand, since the CPU performance of the client 2 is equal to or more than the specified value, the client load calculating unit 408B sets the value that is the value shown in FIG. 5 minus 1, or 2, as the evaluated value of the CPU load for the client 2.

The file transmission load calculating unit 409 also includes the server load calculating unit 409A and the client load calculating unit 409B. The file transmission load calculating unit 409 reflects the network performance of the server 1 and client 2 in addition to a file transmission quantity when the file transmission load calculating unit 409 calculates the evaluated value of file transmission load. For example, the network performance obtains the value (such as available bandwidth) showing the network performance of the server 1 and client 2, e.g., at the start of screen image transfer. In response, the file transmission load calculating unit 409 obtains the evaluated value of file transmission load using different calculation methods for the server 1 and client 2 respectively.

For example, the file transmission load calculating unit 409 has available bandwidth of 10 Mbps as a threshold value, applies the calculation method of “add the evaluated value 1 per 3 megabytes in transmission quantity of a file” when the network performance of the device is less than the above threshold value, and applies the calculation method of “add the evaluated value 1 per 4 megabytes” when the network performance of the device is equal to or more than the specified value.

It is described when the data size of a file is 10 megabytes, the available bandwidth of the server 1 is 5 Mbps, and the available bandwidth of the client 2 is 50 Mbps. The server load calculating unit 409A calculates the evaluated value of the file transmission load for the server 1 to be 4 (the value that is obtained when the result of 10÷3 is rounded up) because the network performance of the server 1 is less than the threshold value. On the other hand, the evaluated value of the file transmission load for the client 2 is calculated to be 3 (the value that is obtained when the result of 10÷4 is rounded up) because the network performance of the client 2 is equal to or more than the threshold value.

A screen image transmission load calculating unit 410 also includes a server load calculating unit 410A and a client load calculating unit 410B. The screen image transmission load calculating unit 410 calculates screen image transmission load using the table set in FIG. 6, and further calculates the value that reflects the performance of each of the server 1 and client 2 as the evaluated value of screen image transmission load. Specifically, the screen image transmission load calculating unit 410 checks whether the server 1 or the client 2 includes a dedicated integrated circuit to still image encoding or decoding as performance of each of the server 1 and client 2, e.g., at the start of screen image transfer, and when said integrated circuit is included, the screen image transmission load calculating unit 410 sets as the evaluated value of screen image transmission load the value that is the evaluated value of screen image transmission load set in FIG. 6 minus 1.

Now, assume that the client 2 includes a dedicated integrated circuit to decoding. The server load calculating unit 410A calculates the value shown in FIG. 6, or 5, as the evaluated value of the screen image transmission load for the server 1 at the time of the detection of a video replay command. On the other hand, the client load calculating unit 410B sets the value that is the value shown in FIG. 6 minus 1, or 4, as the evaluated value of the screen image transmission load for the client 2.

The CPU utilization calculating unit 111 calculates the evaluated value of the CPU utilization of each of the server 1 and client 2 from the current CPU utilization of each of the server 1 and client 2, as described in the first example.

In each of the CPU load calculating unit 408, the file transmission load calculating unit 409, the screen image transmission load calculating unit 410, and the CPU utilization calculating unit 111 that calculate as described above, the evaluated value of the load of each of the server 1 and client 2 is input into a server runtime load calculating unit 412 and a client runtime load calculating unit 413.

The server runtime load calculating unit 412 calculates from said input evaluated value the evaluated value showing the quality of screen image transfer (the evaluated value of server runtime load) of each of the server 1 and client 2 of when the server 1 runs the application. A server load calculating unit 412A of the server runtime load calculating unit 412 calculates the evaluated value of the server runtime load of the server 1 to be the sum of the evaluated values for the server 1 calculated by the CPU load calculating unit 408, the screen image transmission load calculating unit 410, and the CPU utilization calculating unit 111, that is, 3+5+1=9.

On the other hand, a client load calculating unit 412B calculates the evaluated value of the server runtime load of the client 2 to be the sum of the evaluated values for the client 2 calculated by the screen image transmission load calculating unit 410 and the CPU utilization calculating unit 111, that is, 4+1=5.

The client runtime load calculating unit 413 also calculates from said input evaluated value the evaluated value showing the quality of screen image transfer (the evaluated value of client runtime load) of each of the server 1 and client 2 of when the client 2 runs the application. A server load calculating unit 413A of the client runtime load calculating unit 413 calculates the evaluated value of the client runtime load of the server 1 to be the sum of the evaluated values for the server 1 calculated by the file transmission load calculating unit 409 and the CPU utilization calculating unit 111, that is, 4+1=5.

On the other hand, a client load calculating unit 413B of the client runtime load calculating unit 413 calculates the evaluated value of the client runtime load of the client 2 to be the sum of the evaluated values for the client 2 calculated by the CPU load calculating unit 408, the file transmission load calculating unit 409, and the CPU utilization calculating unit 111, that is, 2+3+1=6.

When four evaluated values calculated by each of the server load calculating unit 412A and the client load calculating unit 412B of the server runtime load calculating unit 412, and the server load calculating unit 413A and the client load calculating unit 413B of the client runtime calculating unit 413 are input, the determining unit 115 determines from these values which runs the application, the server 1 or the client 2.

For example, the determining unit 115 determines that a device except the device whose evaluated value is calculated to be the biggest of the four evaluated values runs the application. The biggest evaluated value in this example is 9 as described above. Said evaluated value is the evaluated value of the server 1 of when the server 1 runs the application. The determining unit 115 therefore determines that the client 2 runs the application in this example.

Thus, the determining unit 115 making a device except the device whose evaluated value is calculated to be the biggest run the application allows the device to be protected against overload. Consequently, the quality of screen image transfer can be improved.

The determining unit 115 may determine which device runs the application, the server 1 or the client 2, using other methods. For example, the determining unit 115 may determine which runs the application, the server 1 or the client 2, by obtaining the sum of the evaluated values calculated by the server load calculating unit 412A and the client load calculating unit 412B of the server runtime load calculating unit 412, obtaining the sum of the evaluated values calculated by the server load calculating unit 413A and the client load calculating unit 413B of the client runtime load calculating unit 413, and comparing the magnitude relation between said sums.

The server 1 according to this variation allows for the determination in consideration of the differences in performance even when the server 1 and the client 2 have differences in performance, such as CPU and network performance, and still image encoding and decoding capability, by calculating and using the evaluated value of the server runtime load of each of the server 1 and client 2 when the server 1 runs the application, and the evaluated value of the client runtime load of each of the server 1 and client 2 when the client 2 runs the application. As a result, each of the server 1 and client 2 can be protected against overload, and the improved quality of screen image transfer can be achieved.

The server 1 can be achieved, for example, by using general-purpose computer equipment as basic hardware. That is, the screen updating information producing unit 101, the encoder 102, the screen updating information transmitter 103, the input unit 104, the application-run detector 105, the input information receiver 106, the CPU load calculating unit 108, the file transmission load calculating unit 109, the screen image transmission load calculating unit 110, the CPU utilization calculating unit 111, the CPU utilization obtaining unit 107, the server runtime load calculating unit 112, the client runtime load calculating unit 113, the application running unit 114, the determining unit 115, and the application running information transmitter 116 can be achieved by a processor installed on the above computer equipment running a program. In this instance, a web server may be achieved by preinstalling the above program on the computer equipment or may be achieved by storing the above program on a storage medium, such as a CD-ROM, or distributing the program via the network, and installing it on the computer equipment accordingly. The same goes for the server 1 according to the variation.

In the server 1 according to this example, the evaluated value of server runtime load and the evaluated value of client runtime load are calculated using the evaluated value of each of the CPU load, file transmission load, screen image transmission load, and CPU utilization, but not limited to this method. They may be calculated using, for example, the two evaluated values of CPU load and screen image transmission load. In this instance, the screen image load calculating unit 110 and the CPU utilization calculating unit 111 may not be included in the configuration of the server 1.

It will be understood that the present invention is not limited to the above embodiment(s), and the components can be modified and embodied without departing from the spirit of the invention in the practical phase. A variety of inventions can also be formed by appropriate combinations of a plurality of components disclosed in the above embodiment(s). Some of the components may be removed from all the components shown in the embodiment(s). In addition, components over different embodiments may be combined accordingly.

While certain embodiments have been described, these embodiments have been presented by way of example only, and are not intended to limit the scope of the invention. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server comprising: a detector that detects a run command of an application;
a CPU load calculating unit that calculates a CPU load when the own server or a client runs the application;
a screen image transmission load calculating unit that calculates a screen image transmission load when the own server runs the application;
a server runtime load calculating unit that calculates from the CPU load and the screen image transmission load a server runtime load when the own server runs the application;
a client runtime load calculating unit that calculates from the CPU load a client runtime load when the client runs the application;
a determining unit that determines which runs the application, the server or the client, from the server runtime load and the client runtime load;
a running unit that runs the application when the determining unit determines that the own server runs it; and
a transmitter that transmits the running information on the application to the client when the determining unit determines that the client runs it.

2. The service of claim 1, wherein the server runtime load calculating unit includes a first server load calculating unit that calculates a first server runtime load that is the own server load when the own server runs the application and a first client load calculating unit that calculates a second server runtime load that is the client load when the own server runs the application,
the client runtime load calculating unit includes a second server load calculating unit that calculates a first client runtime load that is an own server load when the client runs the application and a second client load calculating unit that calculates a second client runtime load that is the client load when the client runs the application, and
the determining unit determines which runs the application, the server or the client, from the first and second server runtime load and the first and second client runtime load.

3. The service of claim 2, wherein the CPU load calculating unit includes a third server load calculating unit that calculates a first CPU load when the own server runs the application and a third client load calculating unit that calculates a second CPU load when the client runs the application,
the screen image transmission frequency calculating unit includes a fourth server load calculating unit that calculates a first screen image transmission load that is an own server screen image transmission load when the own server runs the application and a fourth client load coming-out unit that calculates a second screen image transmission load that is the client screen image transmission load when the own server runs the application,
the first server load calculating unit calculates the first server runtime load from the first CPU load and the first screen image transmission load,
the first client load calculating unit calculates the second server runtime load from the second screen image transmission load, and
the second client load calculating unit calculates the second client runtime load from the second CPU load.

4. The service of claim 3, further comprising a file transmission load calculating unit that calculates a file transmission load from the own server to the client when the client runs the application,
wherein the client runtime load calculating unit further calculates the client runtime load based on the transmission load of the file.

5. The service of claim 4, wherein the file transmission load calculating unit includes a fifth server load calculating unit that calculates a first file transmission load that is an own server file transmission load when the client runs the application and a fifth client load calculating unit that calculates a second file transmission load that is the client file transmission load when the client runs the application,
the second server load calculating unit further calculates the first client runtime load based on the first file transmission load, and
the second client load calculating unit further calculates the second client runtime load based on the second file transmission load.

6. The service of claim 5, further comprising the CPU utilization calculating unit that calculates the CPU utilization of the client and the server,
wherein the server runtime load calculating unit further calculates the server runtime load based on the CPU utilization of the server, and
the client runtime load calculating unit further calculates the client runtime load based on the CPU utilization of the client.
